(19) United States
(12) Patent Application Publication
(10) Pub. No.: US 2025/0329034 A1
(43) Pub. Date: Oct. 23, 2025

(54) VEHICLE-BASED LIDAR-TO-CAMERA DYNAMIC ALIGNMENT

(71) Applicant: GM GLOBAL TECHNOLOGY OPERATIONS LLC, DETROIT, MI (US)

(72) Inventors: Yousef Adnan Omar, Troy, MI (US); Mark Wolski, Warren, MI (US); Hao Yu, Troy, MI (US); Wende Zhang, Birmingham, MI (US)

(21) Appl. No.: 18/641,902

(22) Filed: Apr. 22, 2024

(51) Int. Cl. G06T 7/35; B60W 60/00; G06T 3/60; G06T 7/11; G06T 7/80; G06V 20/58

(52) U.S. Cl. CPC G06T 7/35; G06T 3/60; G06T 7/11; G06T 7/80; B60W 60/00; B60W 2420/403; B60W 2420/408; G06T 2207/10028; G06T 2207/20076; G06T 2207/30261; G06V 20/58; G06V 2201/08

(57) ABSTRACT

Examples described herein provide a method that includes collecting image data associated with a camera sensor of a vehicle and light detecting and ranging (LiDAR) data associated with a LiDAR sensor of the vehicle, wherein the image data and the LiDAR data were collected while an autonomous system of the vehicle was disengaged and prior to an occurrence of an alignment trigger. The method further includes, responsive to the occurrence of the alignment trigger, aligning the LiDAR sensor with the camera sensor by performing an iterative alignment. The method further includes, responsive to the autonomous system of the vehicle being engaged and after aligning the LiDAR sensor with the camera sensor, autonomously operating the vehicle.

The subject disclosure relates to vehicles, and in particular to vehicle-based light detection and ranging (LiDAR)-to-camera dynamic alignment.

Modern vehicles (e.g., a car, a motorcycle, a boat, or any other type of automobile) may be equipped with one or more cameras that provide back-up assistance, take images of the vehicle driver to determine driver drowsiness or attentiveness, provide images of the road as the vehicle is traveling for collision avoidance purposes, provide structure recognition, such as roadway signs, etc. For example, a vehicle can be equipped with multiple cameras, and images from multiple cameras (referred to as “surround view cameras”) can be used to create a “surround” or “bird's eye” view of the vehicle. Some of the cameras (referred to as “long-range cameras”) can be used to capture long-range images (e.g., for object detection for collision avoidance, structure recognition, etc.).

Such vehicles can also be equipped with sensors such as a radar device(s), LiDAR device(s), and/or the like for perception tasks. LiDAR involves using light (e.g., a pulsed laser) to measure distance to objects by emitting laser pulses, detecting a reflection (e.g., off of an object) of the emitted laser pulse, and measuring the time between the emission and the detection. The measured time can be used to determine the distance between the LiDAR device and the detected object. Perception tasks can include one or more of object detection, classification, tracking, lane detection, road sign recognition, and obstacle avoidance. Perception tasks are particularly useful for an autonomous vehicle to provide the autonomous vehicle with real-time awareness of its environment to make safe and informed driving decisions. Images from the one or more cameras of the vehicle can also be used for detecting objects, tracking targets, and/or the like, including combinations and/or multiples thereof.

### SUMMARY

In one embodiment, a method is provided. The method includes collecting image data associated with a camera sensor of a vehicle and light detecting and ranging (LiDAR) data associated with a LiDAR sensor of the vehicle, wherein the image data and the LiDAR data were collected while an autonomous system of the vehicle was disengaged and prior to an occurrence of an alignment trigger. The method further includes, responsive to the occurrence of the alignment trigger, aligning the LiDAR sensor with the camera sensor by performing an iterative alignment. The iterative alignment includes generating a plurality of alignment trials by injecting random rotational error in initial extrinsic parameters of a LiDAR sensor of the vehicle. The iterative alignment further includes, for each of the plurality of alignment trials, generating an alignment score and rotational values. The iterative alignment further includes estimating a final confidence measure using the rotational values for each of the plurality of alignment trials. The iterative alignment further includes updating a coordinate transformation matrix based at least in part on the rotational values. The method further includes, responsive to the autonomous system of the vehicle being engaged and after aligning the LiDAR sensor with the camera sensor, autonomously operating the vehicle.

In addition to one or more of the features described herein, or as an alternative, further embodiments of the method may include that collecting the image data and the LiDAR data includes receiving the image data from the camera sensor of the vehicle. The collecting further includes receiving the LiDAR data from the LiDAR sensor of the vehicle. The collecting further includes processing the image data and the LiDAR data. The collecting further includes performing candidate selection on results of processing the image data and the LiDAR data based on at least one selection criteria. The collecting further includes, responsive to determining that the results of processing the image data and the LiDAR data satisfy the at least one selection criteria, saving intermediate alignment features.

In addition to one or more of the features described herein, or as an alternative, further embodiments of the method may include that saving the intermediate alignment features includes saving pixel coordinates of contour pixels for vehicle contours from the image data and saving convex hull points from the LiDAR data.

In addition to one or more of the features described herein, or as an alternative, further embodiments of the method may include that the intermediate alignment features are saved to a buffer.

In addition to one or more of the features described herein, or as an alternative, further embodiments of the method may include that performing the candidate selection is based on determining whether a normalized intersection-over-union value satisfies a threshold.

In addition to one or more of the features described herein, or as an alternative, further embodiments of the method may include that the normalized intersection-over-union value is calculated by dividing an overlap between a first bounding box of a detected vehicle from the image data and a second bounding box of the detected vehicle from the LiDAR data by a union of the first bounding box of the detected vehicle from the image data and the second bounding box of the detected vehicle from the LiDAR data and multiplying by a normalizing function based on distance.

In addition to one or more of the features described herein, or as an alternative, further embodiments of the method may include that the iterative alignment further includes comparing the alignment score for each of the plurality of alignment trials to a threshold and discarding any alignment score failing to satisfy the threshold prior to estimating the final confidence measure.

In addition to one or more of the features described herein, or as an alternative, further embodiments of the method may include that the final confidence measure is estimated using the following equation: 1−α(σ_{pitch}+σ_{yaw}+σᵣₒₗₗ) where α is a scaling factor based on a field of view of the camera sensor, σ_{pitch} is a standard deviation of pitch, σ_{yaw} is a standard deviation of yaw, and σᵣₒₗₗ is a standard deviation of roll.

In addition to one or more of the features described herein, or as an alternative, further embodiments of the method may include that α decreases for camera sensors having a relatively wide field of view and wherein α increases for camera sensors having a relatively narrow field of view.

In addition to one or more of the features described herein, or as an alternative, further embodiments of the method may include that updating the coordinate transformation matrix is based on a median of a pitch value, a yaw value, and a roll value for each of the plurality of alignment trials.

In addition to one or more of the features described herein, or as an alternative, further embodiments of the method may include that each of the pitch value, the yaw value, and the roll value define respective pitch, yaw, and roll relationships between the LiDAR sensor and the camera sensor.

In another embodiment, a vehicle is provided. The vehicle includes a processing system that includes a method having computer readable instructions and a processing device for executing the computer readable instructions, the computer readable instructions controlling the processing device to perform operations. The operations include causing to be collected image data associated with the camera sensor of a vehicle and light detecting and ranging (LiDAR) data associated with a LiDAR sensor of the vehicle, wherein the image data and the LiDAR data are collected while an autonomous system of the vehicle is disengaged and prior to an occurrence of an alignment trigger. The operations further include, responsive to the occurrence of the alignment trigger, aligning the LiDAR sensor with the camera sensor by performing an iterative alignment. The iterative alignment includes generating a plurality of alignment trials by injecting random rotational error in initial extrinsic parameters of a LiDAR sensor of the vehicle. The iterative alignment further includes, for each of the plurality of alignment trials, generating an alignment score and rotational values. The iterative alignment further includes estimating a final confidence measure using the rotational values for each of the plurality of alignment trials. The iterative alignment further includes updating a coordinate transformation matrix based at least in part on the rotational values. The operations further include, responsive to the autonomous system of the vehicle being engaged and after aligning the LiDAR sensor with the camera sensor, autonomously operating the vehicle.

In addition to one or more of the features described herein, or as an alternative, further embodiments of the vehicle may include that causing the collecting the image data and the LiDAR data includes receiving the image data from the camera sensor of the vehicle. The collecting further includes receiving the LiDAR data from the LiDAR sensor of the vehicle. The collecting further includes processing the image data and the LiDAR data. The collecting further includes performing candidate selection on results of processing the image data and the LiDAR data based on at least one selection criteria. The collecting further includes, responsive to determining that the results of processing the image data and the LiDAR data satisfy the at least one selection criteria, saving intermediate alignment features by saving pixel coordinates of contour pixels for vehicle contours from the image data and saving convex hull points from the LiDAR data.

In addition to one or more of the features described herein, or as an alternative, further embodiments of the vehicle may include that the processing system further includes a buffer, wherein the intermediate alignment features are saved to the buffer.

In addition to one or more of the features described herein, or as an alternative, further embodiments of the vehicle may include that performing the candidate selection is based on determining whether a normalized intersection-over-union value satisfies a threshold, wherein the normalized intersection-over-union value is calculated by dividing an overlap between a first bounding box of a detected vehicle from the image data and a second bounding box of the detected vehicle from the LiDAR data by a union of the first bounding box of the detected vehicle from the image data and the second bounding box of the detected vehicle from the LiDAR data and multiplying by a normalizing function based on distance.

In addition to one or more of the features described herein, or as an alternative, further embodiments of the vehicle may include that the iterative alignment further includes comparing the alignment score for each of the plurality of alignment trials to a threshold and discarding any alignment score failing to satisfy the threshold prior to estimating the final confidence measure.

In addition to one or more of the features described herein, or as an alternative, further embodiments of the vehicle may include that the final confidence measurement is estimated using the following equation: 1−α(σ_{pitch}+σ_{yaw}+σᵣₒₗₗ) where α is a scaling factor based on a field of view of the camera sensor, σ_{pitch} is a standard deviation of pitch, σ_{yaw} is a standard deviation of yaw, and σᵣₒₗₗ is a standard deviation of roll, wherein α decreases for camera sensors having a relatively wide field of view and wherein α increases for camera sensors having a relatively narrow field of view.

In addition to one or more of the features described herein, or as an alternative, further embodiments of the vehicle may include that updating the coordinate transformation matrix is based on a median of a pitch value, a yaw value, and a roll value for each of the plurality of alignment trials, wherein each of the pitch value, the yaw value, and the roll value define respective pitch, yaw, and roll relationships between the LiDAR sensor and the camera sensor.

In another embodiment a computer program product is provided. The computer program product includes a computer readable storage medium having program instructions embodied therewith, the program instructions executable by at least one processor to cause the at least one processor to perform operations. The operations include causing a collecting of image data associated with a camera sensor of a vehicle and light detecting and ranging (LiDAR) data associated with a LiDAR sensor of the vehicle, wherein the image data and the LiDAR data are collected while an autonomous system of the vehicle is disengaged and prior to an occurrence of an alignment trigger. The operations further include responsive to the occurrence of the alignment trigger, aligning the LiDAR sensor with the camera sensor by performing an iterative alignment. The iterative alignment includes generating a plurality of alignment trials by injecting random rotational error in initial extrinsic parameters of a LiDAR sensor of the vehicle. The iterative further includes, for each of the plurality of alignment trials, generating an alignment score and rotational values. The iterative further includes estimating a final confidence measure using the rotational values for each of the plurality of alignment trials. The iterative further includes updating a coordinate transformation matrix based at least in part on the rotational values. The operations further include, responsive to the autonomous system of the vehicle being engaged and after aligning the LiDAR sensor with the camera sensor, autonomously operating the vehicle.

In addition to one or more of the features described herein, or as an alternative, further embodiments of the computer program product may include that causing the collecting the image data and the LiDAR data includes: receiving the image data from the camera sensor of the vehicle. The collecting further includes receiving the LiDAR data from the LiDAR sensor of the vehicle. The collecting further includes processing the image data and the LiDAR data. The collecting further includes performing candidate selection on results of processing the image data and the LiDAR data based on determining whether a normalized intersection-over-union value satisfies a threshold, wherein the normalized intersection-over-union value is calculated by dividing an overlap between a first bounding box of a detected vehicle from the image data and a second bounding box of the detected vehicle from the LiDAR data by the union of the first bounding box of the detected vehicle from the image data and the second bounding box of the detected vehicle from the LiDAR data and multiplying by a normalizing function based on distance. The collecting further includes, responsive to determining that the results of processing the image data and the LiDAR data satisfy at least one selection criteria, saving intermediate alignment features by saving pixel coordinates of contour pixels for vehicle contours from the image data and saving convex hull points from the LiDAR data, wherein the intermediate alignment features are saved to a buffer.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of a vehicle having a processing system for performing vehicle-based LiDAR-to-camera dynamic alignment according to one or more embodiments;

FIG. 2 is a block diagram of the processing system of FIG. 1 for performing vehicle-based LiDAR-to-camera dynamic alignment according to one or more embodiments;

FIG. 3 is a flow diagram of a method for performing vehicle-based LiDAR-to-camera dynamic alignment according to one or more embodiments;

FIG. 4A is a flow diagram of a method for collecting data for performing vehicle-based LiDAR-to-camera dynamic alignment according to one or more embodiments;

FIG. 4B is a flow diagram of a method for performing vehicle-based LiDAR-to-camera dynamic alignment according to one or more embodiments;

FIG. 5 is an image used for a normalized intersection-over-union filter for LiDAR-to-camera alignment according to one or more embodiments; and

FIG. 6 is a block diagram of a processing system for implementing one or more embodiments described herein.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein relates to vehicle-based LiDAR-to-camera dynamic alignment. Such embodiments enable perception tasks to be performed on autonomous vehicles.

Autonomous vehicles include one or more sensors (e.g., cameras, LiDAR sensor, and/or the like, including combinations and/or multiples thereof) to collect data that is then used to perform perception tasks. Perception tasks can include one or more of object detection, classification, tracking, lane detection, road sign recognition, and obstacle avoidance. Perception tasks are particularly useful for an autonomous vehicle to provide the autonomous vehicle with real-time awareness of its environment to make safe and informed driving decisions. Often, data from multiple different types of sensors can be used to improve the results of perception tasks and/or to verify perception tasks. For example, a camera sensor can capture an image of an environment around an autonomous vehicle. Image processing techniques can be performed to detect, for example, an object in the image. A LiDAR sensor can capture three-dimensional (3D) points associated with objects in the environment. For example, a LiDAR sensor can capture 3D points associated with the object that is shown in the image. In some situations, the camera sensor and the LiDAR sensor may not be sufficiently aligned.

In cases where the LiDAR sensor is not sufficiently aligned with the camera sensor, the object detected in the image from the camera sensor and 3D points associated with the object detected by the LiDAR sensor may differ. Misalignment can be caused, for example, by normal wear-and-tear (e.g., vibrations caused by driving, minor collisions, and/or the like, including combinations and/or multiples thereof). Such misalignment between a LiDAR sensor and a camera sensor can cause the functioning of an autonomous vehicle to be undesirable. For example, when a LiDAR sensor becomes misaligned with respect to a camera sensor, the autonomous vehicle may not be able to perform perception tasks with suitable accuracy or reliability for autonomous vehicle operation. In such cases, an autonomous system of the autonomous vehicle may be disengaged, with vehicle operations being turned over to an operator (e.g., a driver) of the vehicle. That is, when the autonomous system is disengaged, an operator of the vehicle is responsible for controlling operations of the vehicle because the autonomous system is no longer controlling the vehicle.

One or more embodiments described herein address these and other shortcomings by providing an accurate and efficient dynamic approach to calibrate LiDAR-to-camera extrinsic parameters using vehicle targets to align a LiDAR sensor with a camera sensor. As used herein, extrinsic parameters refer to the spatial relationship between different sensors (e.g., camera sensors, LiDAR sensors, and/or the like, including combinations and/or multiples thereof) and define the pose (e.g., position and orientation) of a sensor relative to a coordinate system (e.g., a global coordinate system, a coordinate system of another sensor, and/or the like, including combinations and/or multiples thereof). As an example, extrinsic parameters can define a translation (e.g., movement along an x-axis, y-axis, and/or z-axis) and/or a rotation (e.g., roll, yaw, and/or roll) of a sensor relative to another sensor.

The proposed approach can overcome challenging corner cases and efficiently generate precise extrinsic parameters using a continuous alignment strategy, which is particularly useful in autonomous vehicles. Moreover, one or more embodiments can execute periodically on a vehicle to adjust relative LiDAR-camera pose changes, enabling sensor-fusion and perception tasks to operate accurately. One or more embodiments provide for accurately estimating LiDAR-to-camera extrinsic parameters using an iterative multi-instance alignment algorithm. One or more embodiments provide for accurately estimating LiDAR-to-camera extrinsic parameters using a confidence estimation approach based on analyzing the correlation of multiple instances.

According to one or more embodiments, a LiDAR sensor is continuously aligned with a camera sensor on an autonomous vehicle with minimum downtime of the autonomous system and low utilization of system memory of the autonomous system. For example, an autonomous vehicle can continuously align a LiDAR sensor with a camera sensor while the autonomous vehicle is operating (e.g., driving on a road) while using limited system memory resources.

According to one or more embodiments, a LiDAR-to-camera iterative alignment approach is provided that is based on initiating multiple trials of converging an objective function by injecting various rotational errors into an initial coordinate transformation matrix (CTM) and analyzing the stability of the trials. The CTM specifies values for transforming LiDAR data captured by a LiDAR sensor to align with image data captured by a camera sensor. The CTM can store values to modify the pitch, yaw, and/or roll (including combinations thereof) of the LiDAR data.

According to one or more embodiments, a statical LiDAR-to-camera confidence measurement is provided that is based on alignment trials.

According to one or more embodiments, a normalized intersection-over-union (IoU) filter is described that provides for selecting high quality data candidates for LiDAR-to-camera alignment. The normalized IoU filter can be used, for example, to automatically remove false LiDAR-camera feature pairings used for alignment.

It should be appreciated that the functioning of any autonomous vehicle implementing one or more of the embodiments described herein is improved. For example, when a LiDAR sensor becomes misaligned relative to a camera sensor, existing approaches begin collecting data to re-align the LiDAR sensor with the camera sensor only after the occurrence of a trigger event that initiates the alignment. This approach is time consuming and inefficient in terms of memory resource usage. In contrast, one or more embodiments described herein continuously collect data before the alignment is triggered while the autonomous system is operating nominally but not engaged (e.g., not operating the vehicle autonomously). Once the autonomous system is disengaged due to misalignment, the LiDAR-to-camera alignment described herein can be performed immediately without spending time or system resources (e.g., processing resources or memory resources) to collect additional data for performing the alignment because the data (e.g., image data and LiDAR data) is already available. Thus, the LiDAR-to-camera alignment approaches described herein can be performed more quickly and efficiently than existing approaches, resulting in a reduced amount of time that the autonomous system is disengaged, thereby improving the functioning of the autonomous vehicle.

Further, the functioning of a processing system of the autonomous vehicle implementing one or more embodiments described herein is improved because the processing system uses fewer system resources (e.g., processing resources, memory resources, data storage resources, bandwidth, and/or the like, including combinations and/or multiples thereof) to perform a LiDAR-to-camera alignment compared with existing systems/approaches. For example, many existing LiDAR-to-camera alignment techniques wait until an autonomous system is disengaged to begin collecting data for alignment and then spend time and system resources collecting the data (e.g., image data and LiDAR data). In contrast, one or more embodiments described herein continuously collect data while the autonomous system is disengaged but prior to the occurrence of the alignment trigger, which uses less system resources than waiting until alignment trigger to begin the data collection and alignment tasks.

One or more embodiments described herein provide one or more of the following advantages: reduced manual labor for LiDAR-to-camera alignment; reduced cycle time for dynamic LiDAR-to-camera alignment; consistent and accurate LiDAR-to-camera alignment; reduced sensitive to input noise, especially when the detected features across sensor modalities do not match well; and/or the like, including combinations and/or multiples thereof.

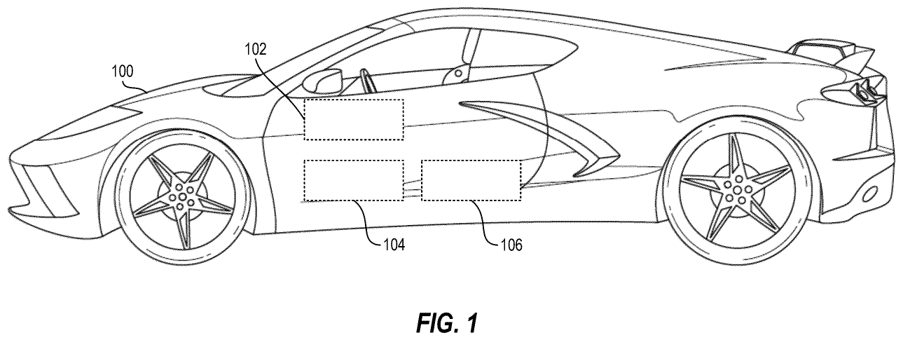

FIG. 1 is an illustration of a vehicle 100 having an autonomous system 102 for performing a vehicle-based LiDAR-to-camera dynamic alignment according to one or more embodiments. The vehicle 100 can be a car, a truck, a van, a bus, a motorcycle, a boat, or any other type of automobile. According to an embodiment, the vehicle 100 includes an internal combustion engine fueled by gasoline, diesel, or the like. According to another embodiment, the vehicle 100 is a hybrid electric vehicle partially or wholly powered by electrical power. According to another embodiment, the vehicle 100 is an electric vehicle powered by electrical power.

According to one or more embodiments, the vehicle 100 is an autonomous vehicle and includes the autonomous system 102, a camera sensor 104, and a LiDAR sensor 106. Although a single camera sensor 104 and a single LiDAR sensor 106 are shown, it should be appreciated that the vehicle 100 can include multiple cameras and/or multiple LiDAR sensors.

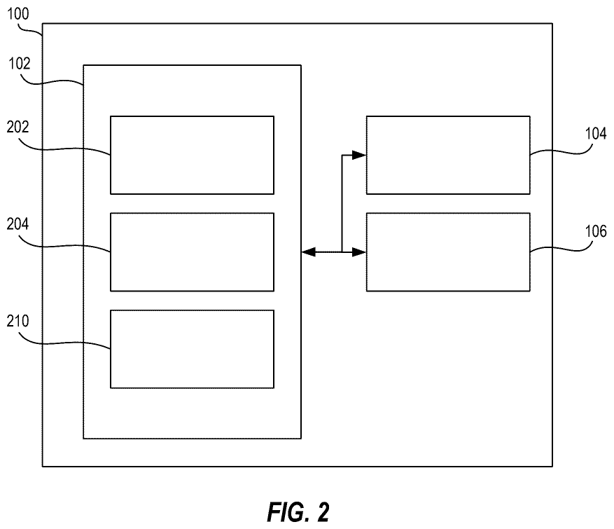

An autonomous vehicle is a vehicle that has self-driving capabilities. For example, the vehicle 100 includes sensors (e.g., the camera sensor 104, the LiDAR sensor 106, and/or the like, including combinations and/or multiples thereof) that send data to the autonomous system 102. The autonomous system 102 can be programmed to navigate and operate the vehicle 100 without human intervention and/or with limited human intervention. The autonomous system 102 can be selectively engaged and disengaged by a user (e.g., an operator of the vehicle 100). When the autonomous system 102 is engaged, the autonomous system 102 can autonomously operate the vehicle 100; when the autonomous system 102 is disengaged, the autonomous system 102 cannot operate the vehicle and instead the vehicle is operated by a user (e.g., an operator). The autonomous system 102 can include hardware and/or software to control the vehicle 100. For example, the autonomous system 102 can include processing resources for processing data and executing instructions, memory resources for storing data and instructions, data storage resources for storing data, communications resources for transmitting and receiving information, and/or the like, including combinations and/or multiples thereof. FIG. 2 shows an example of the autonomous system 102 and is discussed in more detail herein.

The autonomous system 102 can use information collected from the camera sensor 104 and the LiDAR sensor 106 to align the LiDAR sensor 106 to the camera sensor 104, as is further described herein.

FIG. 2 is a block diagram of the autonomous system 102 of FIG. 1 for performing a vehicle-based LiDAR-to-camera dynamic alignment according to one or more embodiments. The autonomous system 102 includes a processing device 202, a memory 204, and an alignment engine 210. It should be appreciated that the autonomous system 102 can be any device suitable for performing a vehicle-based LiDAR-to-camera dynamic alignment. For example, the autonomous system 102 can be a device implemented in or otherwise associated with the vehicle 100. As another example, the autonomous system 102 can be a smartphone, tablet computer, laptop computer, desktop computer, wearable computing device, and/or the like, including combinations and/or multiples thereof.

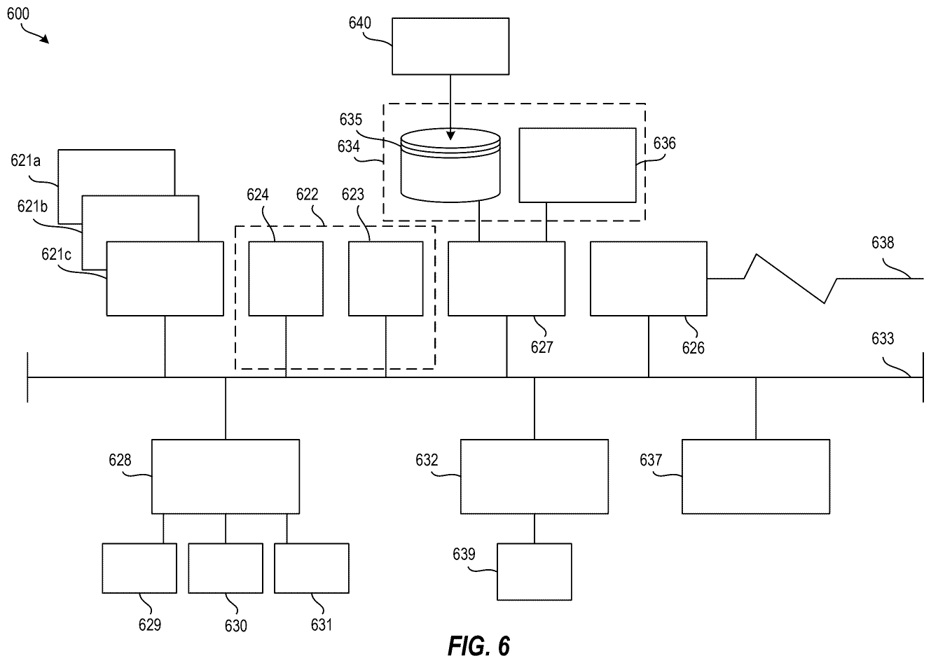

The processing device 202 is any suitable processing circuitry for processing data and/or instructions. The processing device 202 is an example of one or more of the processing devices 621 of FIG. 6, as described in more detail herein.

The memory 204 is any suitable device for storing data and/or instructions. The memory 204 is an example of one or more of the system memory 622, the random access memory 623, and/or the read-only memory 624 of FIG. 6, as described in more detail herein.

The alignment engine 210 performs a vehicle-based LiDAR-to-camera dynamic alignment, as described in more detail herein.

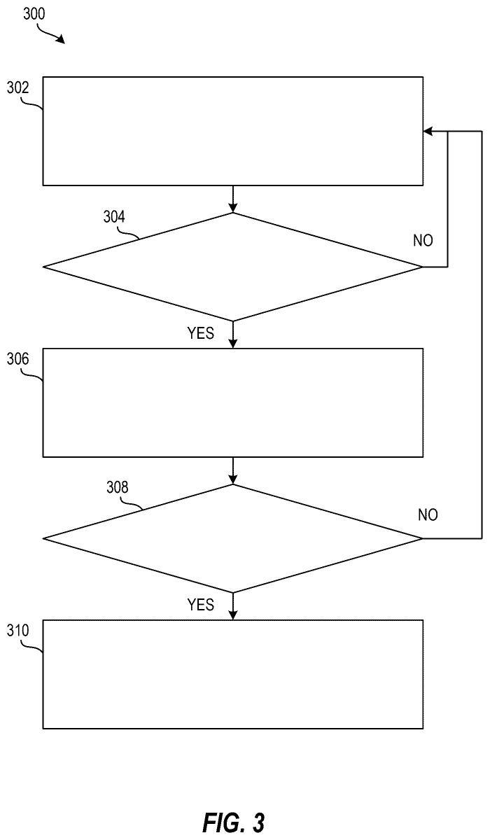

Further aspects and features of the alignment engine 210 are described herein with respect to FIGS. 3, 4A, 4B, and 5.

The various components, modules, engines, etc. described regarding FIG. 2 (e.g., the alignment engine 210) can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 202 for executing those instructions. Thus a system memory (e.g., memory 204) can store program instructions that when executed by the processing device 202 implement the engines described herein. Other engines can also be utilized to include other features and functionality described in other examples herein.

FIG. 3 is a flow diagram of a method 300 for performing vehicle-based LiDAR-to-camera dynamic alignment according to one or more embodiments. The method 300 can be implemented using any suitable system or device. For example, the method 300 can be implemented using the autonomous system 102 of FIGS. 1 and 2, by the processing system 600 of FIG. 6, and/or the like, including combinations and/or multiples thereof. The method 300 is now described with reference to FIGS. 1 and 2 but is not so limited.

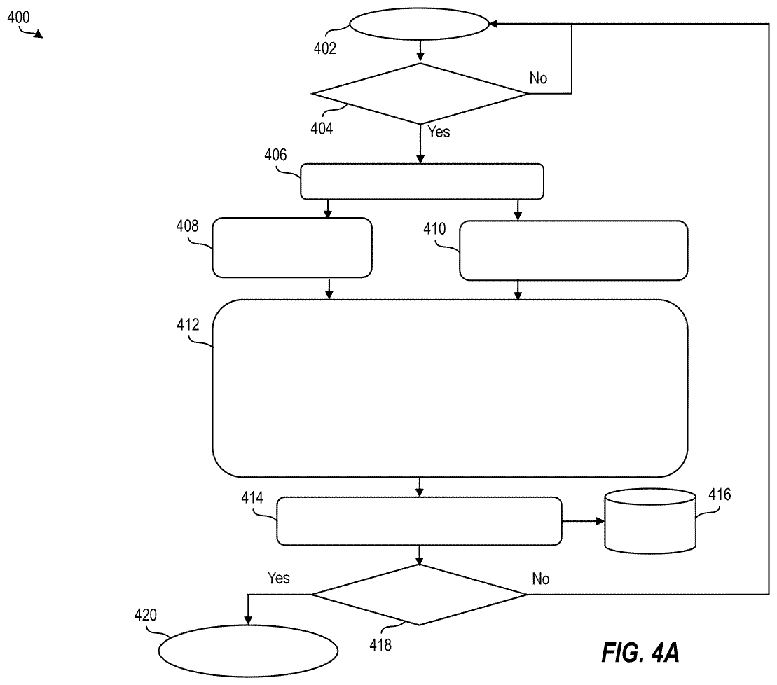

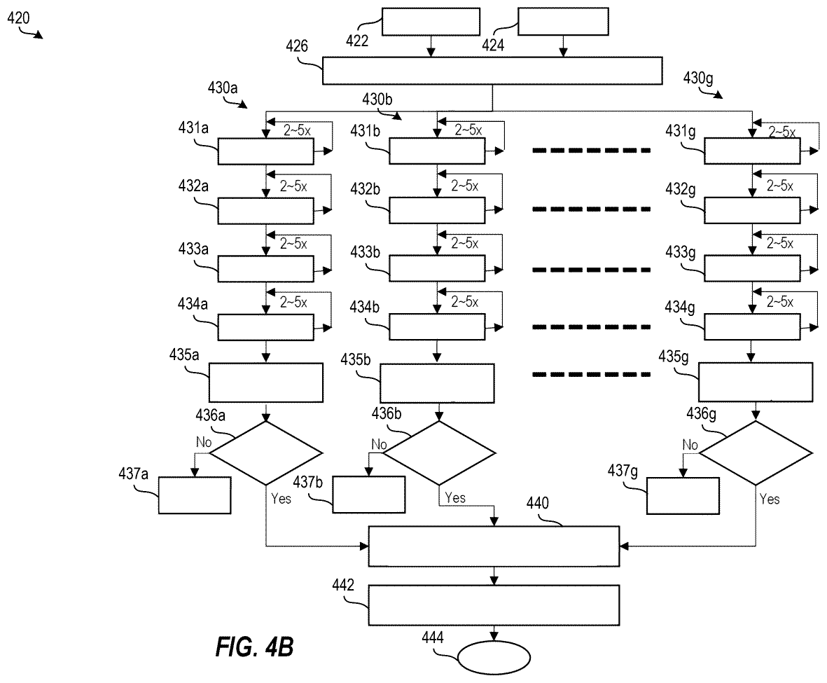

At block 302, the autonomous system 102 (e.g., using the alignment engine 210) collects image data using the camera sensor 104 of the vehicle 100 and collects LiDAR data using the LiDAR sensor 106 of the vehicle 100. According to one or more embodiments, collecting the image data and the LiDAR data includes processing the image data and the LiDAR data, performing candidate selection on results of processing the image data and the LiDAR data based on at least one selection criteria, and responsive to determining that the results of processing the image data and the LiDAR data satisfy the at least one selection criteria, saving intermediate alignment features. According to one or more embodiments, multiple selection criteria are used. In such case, if any of the selection criteria are not satisfied, the LiDAR-camera sample is discarded. According to one or more embodiments, the autonomous system 102 collects the image data and the LiDAR according to the method 400 shown in FIG. 4A, which is described in more detail herein.

At block 304, the autonomous system 102 (e.g., using the alignment engine 210) determines whether an alignment trigger has occurred. An alignment trigger is any suitable action or event that causes a LiDAR-to-camera alignment to be performed as described herein. Examples of alignment triggers include, but are not limited to, a user-initiated trigger, an internal request triggered by vehicle diagnostics, a determination that a LiDAR is not aligned with a camera, a determination that a certain amount of time has passed, a determination that the vehicle 100 has traveled a certain distance, and/or the like, including combinations and/or multiples thereof. If alignment trigger has not occurred (block 304 “NO”), the method 300 returns to block 302, where the autonomous system 102 continues to collect image data and LiDAR data.

However, if it is determined that an alignment trigger has occurred (block 304 “YES”), the method 300 proceeds to block 306. At block 306, the autonomous system 102 (e.g., using the alignment engine 210) performs an iterative alignment to align the LiDAR sensor 106 with the camera sensor 104. According to one or more embodiments, the autonomous system 102 performs the iterative alignment (e.g., performs vehicle-based LiDAR-to-camera dynamic alignment) according to the method 420 shown in FIG. 4B, which is described in more detail herein.

At block 308, the autonomous system 102 determines whether the autonomous system 102 is engaged. The autonomous system 102, when engaged, enables the vehicle 100 to be operated autonomously. If it is determined that the autonomous system 102 is engaged (block 308 “YES), the autonomous system 102 operates the vehicle 100 autonomously at block 310. However, if it is determined that the autonomous system 102 is not engaged (block 308 “NO”), the method 300 returns to block 302, where the autonomous system 102 continues to collect image data and LiDAR data. Accordingly, continuous data collection and LiDAR-to-camera alignment can be performed.

Additional processes also may be included, and it should be understood that the processes depicted in FIG. 3 represent illustrations, and that other processes may be added, or existing processes may be removed, modified, or rearranged without departing from the scope of the present disclosure. It should also be understood that the processes depicted in FIG. 3 may be implemented as programmatic instructions stored on a non-transitory computer-readable storage medium that, when executed by a processor (e.g., the processing device 202 of FIG. 2, the processor(s) 621 of FIG. 6, and/or the like, including combinations and/or multiples thereof) of a computing system (e.g., the autonomous system 102 of FIGS. 1 and 2, the processing system 600 of FIG. 6, and/or the like, including combinations and/or multiples thereof), cause the processor to perform the processes described herein.

FIG. 4A is a flow diagram of a method 400 for collecting data for performing vehicle-based LiDAR-to-camera dynamic alignment according to one or more embodiments. The method 400 can be implemented using any suitable system or device. For example, the method 400 can be implemented using the autonomous system 102 of FIGS. 1 and 2 (e.g., using the alignment engine 210), by the processing system 600 of FIG. 6, and/or the like, including combinations and/or multiples thereof. The method 400 is now described with reference to FIGS. 1 and 2 but is not so limited.

The method 400 is an example of a data collection process performed at block 302 of FIG. 3 according to one or more embodiments.

The method begins at block 402. At block 404, it is determined whether the autonomous system 102 is disengaged. If it is determined that the autonomous system 102 is not disengaged (block 404 “NO”), the method 400 returns to block 402 and restarts. If it is determined that the autonomous system 102 is disengaged (block 404 “YES”), the method 400 proceeds to block 406.

At block 406, the autonomous system 102 collects image data using the camera sensor 104 and collects LiDAR data using the LiDAR sensor 106. According to one or more embodiments, the LiDAR data is a collection of 3D points associated with objects in an environment. Once the image data and the LiDAR data are collected, the method 400 proceeds to block 408 and 410 to process the image data and the LiDAR data.

At block 408, the image data is processed. For example, the autonomous system 102 applies a trained neural network (or other suitable technique, such as any suitably trained machine learning model) to identify potential candidates for performing the LiDAR-to-camera alignment. The trained neural network can be trained to perform image segmentation, which generates bounding boxes around vehicles, for example, or other suitable objects along with a pixel level classification of the object detected.

At block 410, the LiDAR data is processed. For example, the autonomous system 102 applies a density-based spatial clustering of applications with noise (DBScan) operation to group together points that are closely packed (e.g., points with a suitable number of nearby neighbors), effectively filtering out or removing outlier points or points that are otherwise in low-density regions. As a result, a 3D cluster of potential vehicle targets is generated along with an outer contour of the object (e.g., vehicle) when projected on the image data (e.g., an image captured by the camera sensor 104).

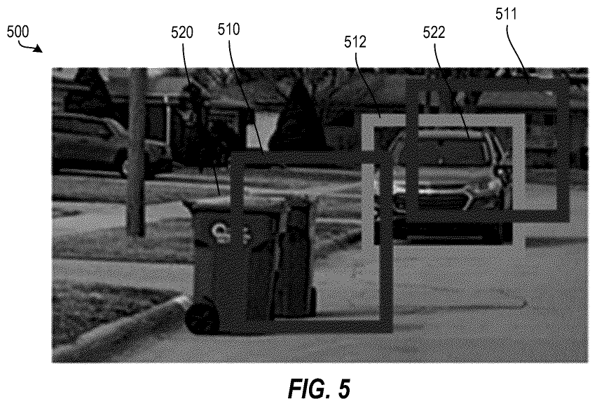

At block 412, the autonomous system 102 selects suitable candidates from the image data and the LiDAR data for performing the LiDAR-to-camera alignment. Various selection criteria can be used to select suitable candidates. According to one or more embodiments, selection criteria can include one or more of the following non-limiting examples: a yaw rate is less than a threshold (e.g., less than substantially 5 degrees per second); a number of edge points is greater than a threshold (e.g., 200) at a certain distance (e.g., substantially 30 meters); a distribution of left/right/center points matches (e.g., a number of left points and a number of right points differ by less than a threshold amount); a structural similarity index measure (SSIM) of two (or more) images is less than a threshold (e.g., substantially 0.7) (e.g., an image is different by the threshold from others that have already been used); a number of vehicles detected by any suitably trained machine learning model to detect vehicles (e.g., a region-based convolutional neural network (R-CNN)) is greater than a threshold (e.g., substantially 2 vehicles); a vehicle image ratio (VIR) (e.g., this measures how much a vehicle occupies from the camera image, where near vehicles (e.g., 10 meters away) cover a larger portion of an image field of view compared to vehicles at a greater distance (e.g., 100 meters away)) is greater than a threshold (e.g., substantially 0.1); a normalized IoU filter is less than a threshold; and/or the like, including combinations and/or multiples thereof. A normalized IoU filter, and the associated candidate selection process, is described herein in more detail with reference to FIG. 5.

With continued reference to FIG. 4A, once the candidate selection process at block 412 is performed and suitable candidates are selected, the method 400 proceeds to block 414. At block 414, the autonomous system 102 saves intermediate alignment features. Intermediate alignment features are those features associated with the candidates identified at blocks 408, 410 that are identified in the image data and the LiDAR data. The intermediate alignment features are the low-level alignment features that are ready to be processed at block 306 of FIG. 3, for example. According to one or more embodiments, no additional processing is needed for the intermediate alignment features, and they are also attributed with low memory usage to buffer them, compared to saving raw camera data and/or raw LiDAR data, which are generally very large in size. In the case of the image data, the candidate alignment features are stored as vehicle contours via storing pixel coordinates of contour pixels. In the case of LiDAR data, the candidate alignment features are stored as vehicle convex hull points. According to one or more embodiments, the intermediate alignment features can be stored to a buffer 416 or another suitable location (e.g., the memory 204 of FIG. 2).

The method 400 then proceeds to block 418, where the autonomous system 102 determines whether an alignment trigger has occurred. An alignment trigger is any suitable action or event that causes a LiDAR-to-camera alignment to be performed as described herein. If an alignment trigger has not occurred (block 418 “NO”), the method 400 returns to block 402, where the autonomous system 102 continues to the data collection process.

However, if it is determined that an alignment trigger has occurred (block 418 “YES”), the method 400 proceeds to perform an iterative alignment in method 420 as described herein. An example of performing alignment (e.g., performing vehicle-based LiDAR-to-camera dynamic alignment) is shown in FIG. 4B and is further described herein.

Additional processes also may be included, and it should be understood that the processes depicted in FIG. 4A represent illustrations, and that other processes may be added, or existing processes may be removed, modified, or rearranged without departing from the scope of the present disclosure. It should also be understood that the processes depicted in FIG. 4A may be implemented as programmatic instructions stored on a non-transitory computer-readable storage medium that, when executed by a processor (e.g., the processing device 202 of FIG. 2, the processor(s) 621 of FIG. 6, and/or the like, including combinations and/or multiples thereof) of a computing system (e.g., the autonomous system 102 of FIGS. 1 and 2, the processing system 600 of FIG. 6, and/or the like, including combinations and/or multiples thereof), cause the processor to perform the processes described herein.

FIG. 4B is a flow diagram of a method 420 for performing vehicle-based LiDAR-to-camera dynamic alignment according to one or more embodiments. The method 420 can be implemented using any suitable system or device. For example, the method 420 can be implemented using the autonomous system 102 of FIGS. 1 and 2 (e.g., using the alignment engine 210), by the processing system 600 of FIG. 6, and/or the like, including combinations and/or multiples thereof. The method 420 is now described with reference to FIGS. 1 and 2 but is not so limited.

The method 420 is an example of an iterative alignment method as performed at block 306 of FIG. 3 and block 420 of FIG. 4A according to one or more embodiments.

At block 422, the autonomous system 102 receives data. The data includes data extracted from the image data and the LiDAR data as described with respect to the method 400 of FIG. 4A. For example, the data is the data stored in the buffer 416.

At block 424, the autonomous system 102 receives an initial CTM. The initial CTM stores initial values defining a relationship in terms of transform and rotation between the LiDAR sensor and the camera sensor. For example, the initial CTM can store initial pitch, yaw, and/or roll values (including combinations thereof) for the rotational relationship between the LiDAR sensor and the camera sensor. When the resulting pitch, yaw, and roll values of the CTM are applied to a properly-aligned LiDAR sensor, the LiDAR data are aligned to a corresponding camera sensor.

At block 426, the autonomous system 102 injects a random rotational error in the initial extrinsic parameters stored in the initial CTM from block 424. For example, the autonomous system 102 can inject an error within an error range (e.g., [−1 degree, +1 degree]) to one or more of pitch, yaw, and roll to generate multiple alignment trials 430 (e.g., alignment instances). In other words, each of the alignment trials 430 receives a different error (e.g., different amount of error, different error regarding roll, yaw, and/or pitch) via injecting the random rotational error in the initial extrinsic parameters stored in the initial CTM from block 426. Each trial 430 attempts to iteratively converge to a desired set of extrinsic parameters independently.

After the error is injected, the autonomous system 102 performs the alignment trials 430. In this example, seven trials 430a-430g are shown; however, it should be appreciated that other numbers of alignment trials 430 (e.g., more or less than 7 alignment trials 430) can be implemented in other embodiments. Using multiple alignment trials 430 reduces the likelihood that the alignment process gets stuck into local minima (e.g., converges to a suboptimal solution instead of the global minimum). Moreover, the correlation in the convergence behavior between alignment trials 430 is a good attribute to define alignment scores. Furthermore, a failure of a specific trial of the alignment trials 430 does not terminate the alignment process; rather, the failed trial can simply be discarded while the remaining alignment trials 430 can still be used.

The alignment trials 430 include multiple levels 431, 432, 433, 434, with each level having a progressively smaller search space. That is, the level 431 has a larger search space than the level 432, which has a larger search space than the level 433, which has a larger search space than the level 434. At each of the levels 431-434, the autonomous system 102 evaluates the rotational properties of the LiDAR sensor including the injected random error from block 426 to determine whether alignment can be improved. Each level 431-434 can be performed multiple times (e.g., two times, three times, four times, five times, and/or the like, including combinations and/or multiples thereof). After level 431-434 is performed, the automated system 102 generates, at blocks 435a-435g, rotational values (e.g., a pitch value, a yaw value, and a roll value) and an alignment score.

For each of the alignment trials 430, the alignment score is compared to a threshold at blocks 436a-436g. If an alignment score for an alignment trial falls below the threshold at block 436, the trial is discarded at block 437. Otherwise, the rotational values for each of the alignment trials 430 are used to estimate a final confidence measurement at block 440. According to one or more embodiments, at block 440, the autonomous system 102 estimates a final confidence measurement using the following equation:

$$1 - α ( {σ}_{pitch} + {σ}_{yaw} + {σ}_{roll} )$$

where α is a scaling factor based on a field of view of the camera sensor, σ_{pitch} is a standard deviation of pitch, σ_{yaw} is a standard deviation of yaw, and σᵣₒₗₗ is a standard deviation of roll. According to one or more embodiments, the scaling factor α can be adjusted to account for different fields of view for the camera sensor 104. For example, a decreases for camera sensors having a relatively wide field of view and a increases for camera sensors having a relatively narrow field of view.

At block 442, the autonomous system 102 updates the initial CTM (from block 424) using rotational values from the alignment trials 430. For example, the CTM is updated by using median values for the pitch value, the yaw value, and the roll value for each of the trials where the alignment score exceeded the threshold. As another example, the CTM is updated by using average/mean values for the pitch value, the yaw value, and the roll value for each of the trials where the alignment score exceeded the threshold. As yet another example, the CTM is updated by using minimum or maximum values for the pitch value, the yaw value, and the roll value for each of the trials where the alignment score exceeded the threshold. The updated CTM can then be used to align the LiDAR sensor 104 and the camera sensor 106. The method 420 then proceeds to block 444 and ends.

Additional processes also may be included, and it should be understood that the processes depicted in FIG. 4B represent illustrations, and that other processes may be added, or existing processes may be removed, modified, or rearranged without departing from the scope of the present disclosure. It should also be understood that the processes depicted in FIG. 4B may be implemented as programmatic instructions stored on a non-transitory computer-readable storage medium that, when executed by a processor (e.g., the processing device 202 of FIG. 2, the processor(s) 621 of FIG. 6, and/or the like, including combinations and/or multiples thereof) of a computing system (e.g., the autonomous system 102 of FIGS. 1 and 2, the processing system 600 of FIG. 6, and/or the like, including combinations and/or multiples thereof), cause the processor to perform the processes described herein.

FIG. 5 is an image 500 used for a normalized IoU filter for LiDAR-to-camera alignment according to one or more embodiments. The normalized IoU filter provides for selecting high quality data candidates for LiDAR-to-camera alignment. The normalized IoU filter can be used, for example, to automatically remove false LiDAR-camera feature pairings used for alignment.

When performing the LiDAR-to-camera alignment as described herein, features are extracted from the image data and the LiDAR data used for alignment as follows. For the image data, the neural network performing segmentation, as described herein, generates as output bounding boxes of detected vehicles along with pixel-level classifications of the detected vehicle. For the LiDAR data, the outputs are 3D clusters of potential vehicle targets along with the outer contour of those objects when projected on an image of the image data.

However, many objects in a scene can be misclassified from both sensor modalities (e.g., the camera sensor 104 and the LiDAR sensor 106). For example, in the case of the image data, the neural network performing segmentation can generate noisy results classifying random objects (e.g., a trash can) as a vehicle. For LiDAR data, a 3D cluster of objects, such as trees, bushes, elevated terrain, signs, and/or the like, including combinations and/or multiples thereof, can have similar dimensions of real vehicles and can therefore be misclassified. These examples represent false LiDAR-camera feature pairings and contribute noise and create local minima for the iterative alignment process.

To address these and other shortcomings, one or more embodiments described herein use a normalized IoU filter to ensure that the LiDAR-camera extracted features are paired correctly by removing such false detections. The normalized IoU filter uses distance to a detected object from the vehicle 100.

In FIG. 5, an image 500 is shown that includes three bounding boxes: a LiDAR bounding box 510, a LiDAR bounding box 511, and a camera bounding box 512. The LiDAR bounding box 510 and the LiDAR bounding box 511 are detected from LiDAR data collected by the LiDAR sensor 106, and the camera bounding box 512 is detected from image data collected by the camera sensor 104. As shown in FIG. 5, two overlaps of bounding boxes exist. The LiDAR bounding box 510, which overlaps with the camera bounding box 512, is a false detection: this bounding box is associated with trashcans 520 rather than a detected vehicle 522. In contrast, the LiDAR bounding box 511, which also overlaps with the camera bounding box 512, is a true detection: this bounding box is associated with the detected vehicle 522.

A normalized IoU filter is calculated by dividing an overlap between a first bounding box (e.g., the camera bounding box 512) of a detected vehicle (e.g., the detected vehicle 522) from the image data and a second bounding box (e.g., the LiDAR bounding box 511) of the detected vehicle from the LiDAR data by the union of the first bounding box (e.g., the camera bounding box 512) of the detected vehicle from the image data and the second bounding box (e.g., the LiDAR bounding box 511) of the detected vehicle from the LiDAR data and multiplying by a normalizing function based on distance. More particularly, the normalized IoU filter can be calculated according to the following equation:

$$\tilde{J} ( {C}_{B} , {L}_{B} ) = \frac{\vert {C}_{B} ⋂ {L}_{B} \vert}{\vert {C}_{B} ⋃ {L}_{B} \vert} * F ( D )$$

where J̅ is a normalized Jaccard index formula, C_{B} is the camera bounding box, L_{B} is the LiDAR bounding box, and F(D) is a normalizing function based on distance.

It is understood that one or more embodiments described herein is capable of being implemented in conjunction with any other type of computing environment now known or later developed. For example, FIG. 6 depicts a block diagram of a processing system 600 for implementing the techniques described herein. In accordance with one or more embodiments described herein, the processing system 600 is an example of a cloud computing node of a cloud computing environment. In examples, processing system 600 has one or more central processing units (referred to also as “processors” or “processing resources” or “processing devices”) 621a, 621b, 621c, etc. (collectively or generically referred to as processor(s) 621 and/or as processing device(s) 621). In aspects of the present disclosure, each processor 621 can include a reduced instruction set computer (RISC) microprocessor. Processors 621 are coupled to a system memory 622 and/or various other components via a system bus 633. The system memory 622 can include one or more temporary and/or persistent memory devices, such as a random access memory (RAM) 623, a read-only memory (ROM) 624, and/or the like, including combinations and/or multiples thereof. The system bus 633 may include a basic input/output system (BIOS), which controls certain basic functions of processing system 600.

Further depicted are an input/output (I/O) adapter 627 and a network adapter 626 coupled to system bus 633. I/O adapter 627 may be a small computer system interface (SCSI) adapter that communicates with a hard disk 635 and/or a storage device 636 or any other similar component. I/O adapter 627, hard disk 635, and storage device 636 are collectively referred to herein as mass storage 634. Operating system 640 for execution on processing system 600 may be stored in mass storage 634. The network adapter 626 interconnects system bus 633 with an outside network 638 enabling processing system 600 to communicate with other such systems.

A display (e.g., a display monitor) 639 is connected to system bus 633 by display adapter 632, which may include a graphics adapter to improve the performance of graphics intensive applications and a video controller. In one aspect of the present disclosure, adapters 626, 627, and/or 632 may be connected to one or more I/O buses that are connected to system bus 633 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 633 via user interface adapter 628 and display adapter 632. A keyboard 629, mouse 630, and speaker 631 may be interconnected to system bus 633 via user interface adapter 628, which may include, for example, a Super I/O chip integrating multiple device adapters into a single integrated circuit.

In some aspects of the present disclosure, processing system 600 includes a graphics processing unit (GPU) 637. Graphics processing unit 637 is a specialized electronic circuit designed to manipulate and alter memory to accelerate the creation of images in a frame buffer intended for output to a display. In general, graphics processing unit 637 is very efficient at manipulating computer graphics and image processing and has a highly parallel structure that makes it more effective than general-purpose CPUs for algorithms where processing of large blocks of data is done in parallel.

Thus, as configured herein, processing system 600 includes processing capability in the form of processors 621, storage capability including the system memory 622 and mass storage 634, input means such as keyboard 625 and mouse 630, and output capability including speaker 631 and display 639. In some aspects of the present disclosure, a portion of system memory 622 and mass storage 634 collectively store the operating system 640 to coordinate the functions of the various components shown in processing system 600.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method comprising:
collecting image data associated with a camera sensor of a vehicle and light detecting and ranging (LiDAR) data associated with a LiDAR sensor of the vehicle, wherein the image data and the LiDAR data were collected while an autonomous system of the vehicle was disengaged and prior to an occurrence of an alignment trigger;
responsive to the occurrence of the alignment trigger, aligning the LiDAR sensor with the camera sensor by performing an iterative alignment that comprises:
generating a plurality of alignment trials by injecting random rotational error in initial extrinsic parameters of a LiDAR sensor of the vehicle;
for each of the plurality of alignment trials, generating an alignment score and rotational values;
estimating a final confidence measure using the rotational values for each of the plurality of alignment trials; and
updating a coordinate transformation matrix based at least in part on the rotational values; and
responsive to the autonomous system of the vehicle being engaged and after aligning the LiDAR sensor with the camera sensor, autonomously operating the vehicle.

2. The computer-implemented method of claim 1, wherein collecting the image data and the LiDAR data comprises:
receiving the image data from the camera sensor of the vehicle;
receiving the LiDAR data from the LiDAR sensor of the vehicle;
processing the image data and the LiDAR data;
performing candidate selection on results of processing the image data and the LiDAR data based on at least one selection criteria; and
responsive to determining that the results of processing the image data and the LiDAR data satisfy the at least one selection criteria, saving intermediate alignment features.

3. The computer-implemented method of claim 2, wherein saving the intermediate alignment features comprises:
saving pixel coordinates of contour pixels for vehicle contours from the image data; and
saving convex hull points from the LiDAR data.

4. The computer-implemented method of claim 2, wherein the intermediate alignment features are saved to a buffer.

5. The computer-implemented method of claim 2, wherein performing the candidate selection is based on determining whether a normalized intersection-over-union value satisfies a threshold.

6. The computer-implemented method of claim 5, wherein the normalized intersection-over-union value is calculated by dividing an overlap between a first bounding box of a detected vehicle from the image data and a second bounding box of the detected vehicle from the LiDAR data by a union of the first bounding box of the detected vehicle from the image data and the second bounding box of the detected vehicle from the LiDAR data and multiplying by a normalizing function based on distance.

7. The computer-implemented method of claim 1, wherein the iterative alignment further comprises:
comparing the alignment score for each of the plurality of alignment trials to a threshold; and
discarding any alignment score failing to satisfy the threshold prior to estimating the final confidence measure.

8. The computer-implemented method of claim 1, wherein the final confidence measure is estimated using the following equation:
$$1 - α ( {σ}_{pitch} + {σ}_{yaw} + {σ}_{roll} )$$
where α is a scaling factor based on a field of view of the camera sensor, σ_{pitch} is a standard deviation of pitch, σ_{yaw} is a standard deviation of yaw, and σᵣₒₗₗ is a standard deviation of roll.

9. The computer-implemented method of claim 8, wherein α decreases for camera sensors having a relatively wide field of view and wherein α increases for camera sensors having a relatively narrow field of view.

10. The computer-implemented method of claim 1, wherein updating the coordinate transformation matrix is based on a median of a pitch value, a yaw value, and a roll value for each of the plurality of alignment trials.

11. The computer-implemented method of claim 10, wherein each of the pitch value, the yaw value, and the roll value define respective pitch, yaw, and roll relationships between the LiDAR sensor and the camera sensor.

12. A vehicle comprising:
a camera sensor; and
a processing system, the processing system comprising:
a memory comprising computer readable instructions; and
a processing device for executing the computer readable instructions, the computer readable instructions controlling the processing device to perform operations comprising:
causing to be collected image data associated with the camera sensor of the vehicle and light detecting and ranging (LiDAR) data associated with a LiDAR sensor of the vehicle, wherein the image data and the LiDAR data are collected while an autonomous system of the vehicle is disengaged and prior to an occurrence of an alignment trigger;
responsive to the occurrence of the alignment trigger, aligning the LiDAR sensor with the camera sensor by performing an iterative alignment that comprises:
generating a plurality of alignment trials by injecting random rotational error in initial extrinsic parameters of a LiDAR sensor of the vehicle;
for each of the plurality of alignment trials, generating an alignment score and rotational values;
estimating a final confidence measure using the rotational values for each of the plurality of alignment trials; and
updating a coordinate transformation matrix based at least in part on the rotational values; and
responsive to the autonomous system of the vehicle being engaged and after aligning the LiDAR sensor with the camera sensor, autonomously operating the vehicle.

13. The vehicle of claim 12, wherein causing the collecting the image data and the LiDAR data comprises:
receiving the image data from the camera sensor of the vehicle;
receiving the LiDAR data from the LiDAR sensor of the vehicle;
processing the image data and the LiDAR data;
performing candidate selection on results of processing the image data and the LiDAR data based on at least one selection criteria; and
responsive to determining that the results of processing the image data and the LiDAR data satisfy the at least one selection criteria, saving intermediate alignment features by saving pixel coordinates of contour pixels for vehicle contours from the image data and saving convex hull points from the LiDAR data.

14. The vehicle of claim 13, wherein the processing system further comprises a buffer, wherein the intermediate alignment features are saved to the buffer.

15. The vehicle of claim 13, wherein performing the candidate selection is based on determining whether a normalized intersection-over-union value satisfies a threshold, wherein the normalized intersection-over-union value is calculated by dividing an overlap between a first bounding box of a detected vehicle from the image data and a second bounding box of the detected vehicle from the LiDAR data by a union of the first bounding box of the detected vehicle from the image data and the second bounding box of the detected vehicle from the LiDAR data and multiplying by a normalizing function based on distance.

16. The vehicle of claim 12, wherein the iterative alignment further comprises:
comparing the alignment score for each of the plurality of alignment trials to a threshold; and
discarding any alignment score failing to satisfy the threshold prior to estimating the final confidence measure.

17. The vehicle of claim 12, wherein the final confidence measurement is estimated using the following equation:
$$1 - α ( {σ}_{pitch} + {σ}_{yaw} + {σ}_{roll} )$$
where α is a scaling factor based on a field of view of the camera sensor, σ_{pitch} is a standard deviation of pitch, σ_{yaw} is a standard deviation of yaw, and σᵣₒₗₗ is a standard deviation of roll, wherein α decreases for camera sensors having a relatively wide field of view and wherein α increases for camera sensors having a relatively narrow field of view.

18. The vehicle of claim 12, wherein updating the coordinate transformation matrix is based on a median of a pitch value, a yaw value, and a roll value for each of the plurality of alignment trials, wherein each of the pitch value, the yaw value, and the roll value define respective pitch, yaw, and roll relationships between the LiDAR sensor and the camera sensor.

19. A computer program product comprising a computer readable storage medium having program instructions embodied therewith, the program instructions executable by at least one processor to cause the at least one processor to perform operations comprising:
causing a collecting of image data associated with a camera sensor of a vehicle and light detecting and ranging (LiDAR) data associated with a LiDAR sensor of the vehicle, wherein the image data and the LiDAR data are collected while an autonomous system of the vehicle is disengaged and prior to an occurrence of an alignment trigger;
responsive to the occurrence of the alignment trigger, aligning the LiDAR sensor with the camera sensor by performing an iterative alignment that comprises:
generating a plurality of alignment trials by injecting random rotational error in initial extrinsic parameters of a LiDAR sensor of the vehicle;
for each of the plurality of alignment trials, generating an alignment score and rotational values;
estimating a final confidence measure using the rotational values for each of the plurality of alignment trials; and
updating a coordinate transformation matrix based at least in part on the rotational values; and
responsive to the autonomous system of the vehicle being engaged and after aligning the LiDAR sensor with the camera sensor, autonomously operating the vehicle.

20. The computer program product of claim 19, wherein causing the collecting the image data and the LiDAR data comprises:
receiving the image data from the camera sensor of the vehicle;
receiving the LiDAR data from the LiDAR sensor of the vehicle;
processing the image data and the LiDAR data;
performing candidate selection on results of processing the image data and the LiDAR data based on determining whether a normalized intersection-over-union value satisfies a threshold, wherein the normalized intersection-over-union value is calculated by dividing an overlap between a first bounding box of a detected vehicle from the image data and a second bounding box of the detected vehicle from the LiDAR data by the union of the first bounding box of the detected vehicle from the image data and the second bounding box of the detected vehicle from the LiDAR data and multiplying by a normalizing function based on distance; and
responsive to determining that the results of processing the image data and the LiDAR data satisfy at least one selection criteria, saving intermediate alignment features by saving pixel coordinates of contour pixels for vehicle contours from the image data and saving convex hull points from the LiDAR data, wherein the intermediate alignment features are saved to a buffer.
